(19) United States
(12) Patent Application Publication
(10) Pub. No.: US 2017/0370720 A1
(43) Pub. Date: Dec. 28, 2017

(54) Method for Detecting a Measurement Region in a Substrate

(71) Applicant: Hilti Aktiengesellschaft, Schaan (LI)

(72) Inventors: Torsten Gogolla, Schaan (LI); Dietmar Schoenbeck, Goefis (AT); Sascha Korl, Louisville, CO (US); Jens Neumann, Grabs (CH)

(73) Assignee: Hilti Aktiengesellschaft, Schaan (LI)

(21) Appl. No.: 15/539,032

(22) PCT Filed: Dec. 22, 2015
(86) PCT No.: PCT/EP2015/080983

§ 371 Date: Jun. 22, 2017

(30) Foreign Application Priority Data
Dec. 23, 2014 (EP) 14200185.8

(51) Int. Cl. G01C 15/00; G01V 3/15

(52) U.S. Cl. CPC G01C 15/002; G01V 3/15

(57) ABSTRACT

A method for detecting a measurement region in a substrate, using an arrangement that includes a detector device having a detection field, a localization device, and a control device, is provided. The method includes selecting a measurement region to be detected, which has a start position and coordinates. The dimension of the measurement region to be detected is greater than the detection field of the detector device. The method also includes determining using the localization device an actual position of the detector device, and further determining by the control device an actual detection field from the actual position of the detector device. Moreover, the method includes comparing by the control device the start position of the measurement region to be detected with the actual detection field.

This application claims the priority of International Application No. PCT/EP2015/080983, filed Dec. 22, 2015, and European Patent Document No. 14200185.8, filed Dec. 23, 2014, the disclosures of which are expressly incorporated by reference herein.

### BACKGROUND AND SUMMARY OF THE INVENTION

The present invention relates to a method for detecting a measurement region in a substrate.

A known apparatus for detecting objects in a substrate is disclosed in DE 20 2010 016 564 U1. The apparatus includes a detector device, a localization device, and a control device. The user moves the detector device over the substrate, wherein the detector device executes a series of measurements. During the measurement process, the localization device determines the current position of the detector device on a regular basis. The measurement data of the detector device and the position data of the localization device are transmitted to the control device, which allocates and stores the measurement and position data. The measurement and location data can be further processed by the control device and depicted on a screen, for example.

The object of the present invention is directed to a method for detecting a measurement region in a substrate.

According to one or more embodiments of the invention, the method for detecting a measurement region in a substrate by an apparatus, which includes a detector device having a detection field, a localization device, and a control device, is as follows:
In a first step, one selects a measurement region to be detected having a start position and target coordinates, wherein the dimensions of the measurement region to be detected are greater than the detection field of the detector device,
In a second step, a current position of the detector device is determined using the localization device,
In a third step, a current detection field is determined by the control device from the current position of the detector device, and
In a fourth step, the start position of the measurement region to be detected is compared by the control device against the current detection field of the detector device.

The method according to the invention deals with detecting a measurement region in a substrate and detecting objects that are embedded in the substrate. The term “object” includes all elements that may be located in a substrate. Examples of objects, which are detected by the detector device, are power lines, broadcast cables, empty pipes, water lines, heating pipes, and reinforcing bars.

If the start position is located outside of the current detection field, an adjustment instruction for the detector device is calculated by the control device from the current position of the detector device and the start position of the measurement region to be detected and is depicted on a display device. The user is instructed by the adjustment instruction how the detector device is to be moved over the substrate.

If the start position of the measurement region to be detected is located within the current detection field, the control device issues a command to the detector device to execute at least one measurement in the substrate. The method has the advantage that the control device controls the initiation of the measurements.

If the start position of the measurement region to be detected is located within the current detection field, an adjustment instruction to stop the detector device is generated by the control device and depicted on a display device. In a particularly preferred embodiment, the control device issues a command to the detector device to execute at least one measurement in the substrate when the start position of the measurement region to be detected lies within the current detection field and does not move the detector device.

In a particularly preferred embodiment, during the measurement with the detector device, an adjustment instruction for the detector device is calculated from the coordinates of the measurement region to be detected and the current position of the control device, and is depicted on a display device. The user is instructed by the adjustment instruction how the detector device is to be moved over the substrate.

Preferably, measurements in the substrate are taken with a measurement frequency using the detector device and the measurement values are transmitted using a first transmission frequency by the detector device to the control device.

In a particularly preferred embodiment, the current position of the detector device is determined by the localization device using a localization frequency and the position data is transmitted using a transmission frequency by the localization device to the control device.

In a preferred embodiment, a command is issued by the control device to the detector device to discontinue taking measurements in the substrate, if the coordinates of the measurement region to be detected are located outside of the current detection field. Measurements using the detector device are taken only if the detector device is correctly positioned and the coordinates of the measurement region are located in the detection field of the detector device.

In a particularly preferred embodiment, an adjustment instruction for the detector device is calculated by the control device from the current position of the detector device and the coordinates of the measurement region to be detected, and is depicted on a display device. The user is instructed by the adjustment instruction how the detector device is to be moved over the substrate.

In a particularly preferred embodiment, the control device issues a command to the detector device to execute at least one measurement in the substrate when the coordinates of the measurement region to be detected are located within the current detection field. The method has the advantage that the control device controls the initiation of the measurements. The measurements are taken only when the detector device is correctly positioned and the coordinates of the measurement region are located in the detection field of the detector device.

In a particularly preferred embodiment, the detector device is guided at least two times over the measurement region to be detected, wherein the detector device executes a first measurement using first detection parameters and second measurements using second detection parameters. Via the measurement using different detection parameters, the accuracy and reliability of the measurement data can be increased. Different object and object properties in the substrate may require different detection parameters.

In a further embodiment, the method according to the invention, in a second step, a current orientation of the detector device, in addition to the current position of the detector device, is also determined by the localization device. In a particularly preferred embodiment, in the third step, the current detection field of the detector device is determined by the control device from the current position and the current orientation of the detector device. By determining the current orientation, the accuracy with which the orientation of the detector device can be determined is increased. The current orientation of the detector device can be determined for example using a camera or by the differentiation among multiple known markings, which are applied on the detector device. Here, all known methods are suited for determining the orientation of an object in the room.

Preferably, the current orientation of the detector device is also taken into account in all method steps of the method according to the invention, which use the current position of the detector device.

Embodiments of the invention are described below by the drawing. It is intended to show the embodiments not necessarily to scale; rather the drawing, where useful for explanation purposes, is executed in a schematic and/or slightly distorted manner. Regarding amendments to the teachings directly evident from the drawing, one shall refer to the relevant prior art. In doing so, one shall take into account that diverse modifications and changes pertaining to the form and detail of an embodiment can be undertaken without departing from the general idea of the invention. The features of the invention disclosed in the description, drawing and claims may be essential both individually on their own as well as in any combination for the further development of the invention. Also falling within the scope of the invention are all combinations of at least two of the features disclosed in the description, drawing and/or claims. The general ideal of the invention is not restricted to the exact form or detail of the preferred embodiments depicted and described hereafter, or limited to a subject matter that would be restricted in comparison to the subject matter claimed in the claims. For given measurement ranges, values lying within the mentioned limits shall be disclosed as limit values and one shall be able to use and claim these as one wishes.

For the sake of simplicity, the same reference signs are used for identical or similar parts, or parts with an identical or similar function.

### BRIEF DESCRIPTION OF THE DRAWINGS

FIG. 1 illustrates the application of an apparatus for detecting a measurement region in a substrate designed as a back wall, including a detector device, a localization device and a control device;

FIG. 2 illustrates the back wall of FIG. 1 with a measurement region to be detected;

FIG. 3 illustrates the interaction of the detector device, the localization device, and the control device of the apparatus depicted in FIG. 1 in the form of a block diagram; and

FIG. 4 illustrates a design variant of the method according to the invention for detecting a measurement region in the form of a flow chart.

### DETAILED DESCRIPTION OF THE DRAWINGS

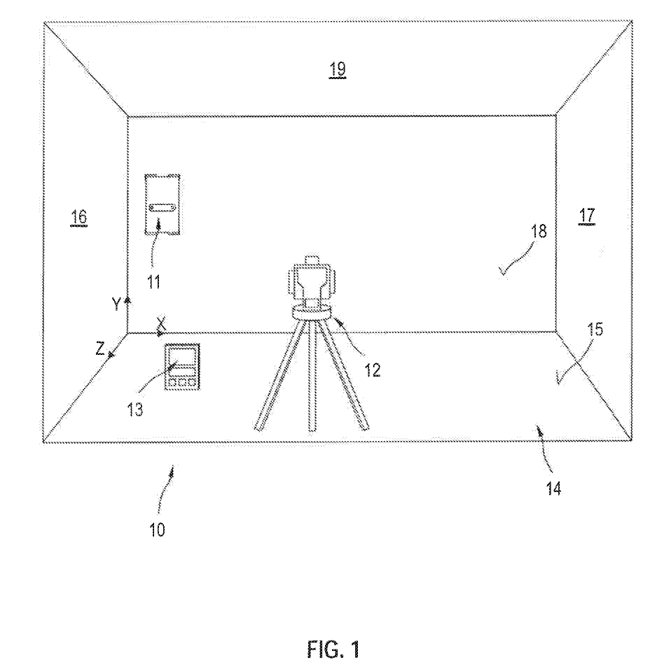

FIG. 1 illustrates an apparatus 10 for executing the method according to the invention for examining object properties of an object in a substrate. The term “object” covers all elements that are located in a substrate. Apparatus 10 includes a detector device 11, a localization device 12, and a control device 13. Detector device 11, localization device 12, and control device 13 are designed as separate components, which can be connected via communication lines and which can communicate with each other. Detector device 11 is designed as a hand-guided detector device that is moved over the substrate during the measuring process.

In regard to detector devices, one differentiates between held and guided detector devices; a held detector device is held over the substrate to be detected during the measurement process without any forward movement, and a guided detector device is guided during the measuring process along a linear path or in any desired path over the substrate to be detected.

The method according to the invention is described by a measurement task in an interior space 14. Interior space 14 consists of a floor 15, a left and right sidewall 16, 17, a back wall 18 and a ceiling 19. The boundaries 15-19 of interior space 14 are covered by the term “boundary surface”. Interior space 14 is spanned by a three-dimensional coordinate system X, Y, Z, whose point of origin (0, 0, 0) is located in the left bottom corner between floor 15, left sidewall 16, and back wall 18.

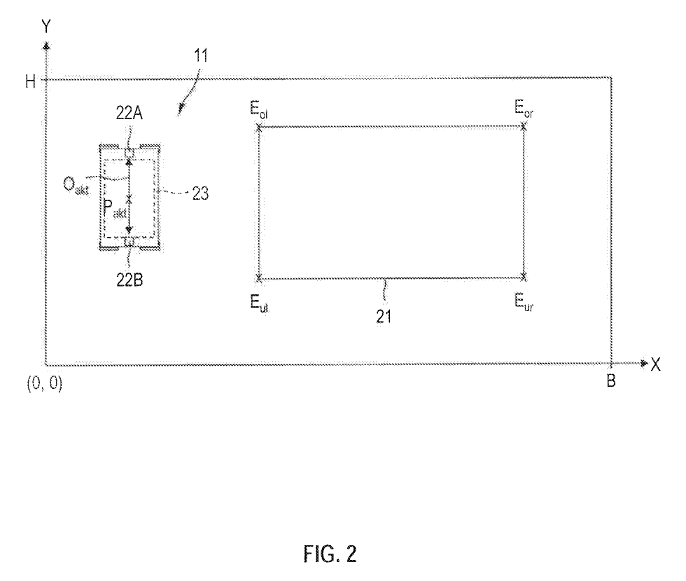

FIG. 2 illustrates back wall 18 of interior space 14 with a measurement region 21 to be detected. Back wall 18 lies in the XY plane of the coordinate system and it has a width B in direction X and a height H in direction Y.

Before measurements are taken using detector device 11, detector device 11 must be positioned over measurement region 21. To do so, using localization device 12, current position Pₐₖₜ is determined using coordinates xₐₖₜ, yₐₖₜ, zₐₖₜ of detector device 11 in interior space 14. Current position Pₐₖₜ of detector device 11 is determined using two localization marks 22A, 22B. In the embodiment, localization marks 22A, 22B are applied to the top side of detector device 11. From the current position Pₐₖₜ of detector device 11, control device 13 determines a current detection field 23 of detector device 11. There is a known relationship between the positions of localization marks 22A, 22B and detection field 23 of detector device 11. A current orientation Oₐₖₜ of detector device 11 may also be determined using localization marks 22A, 22B. After control device 13 has determined current detection field 23 of detector device 11, the start position of measurement region 21 is compared by control device 13 against current detection field 23 of detector device 11.

Measurement region 21 is designed in a rectangular manner and is bounded by four corner points Eᵤₗ, Eₒₗ, Eₒᵣ, Eᵤᵣ. The corner points are suitable as the start position of measurement region 21.

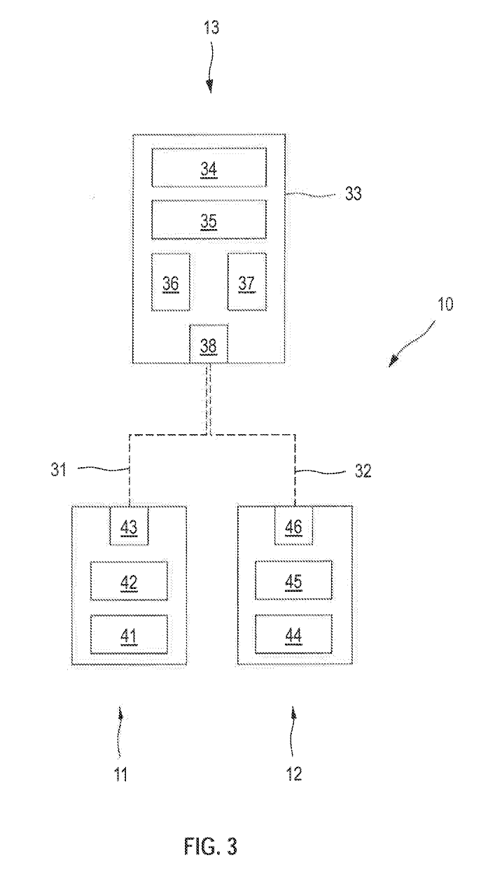

FIG. 3 illustrates the setup and interaction of detector device 11, localization device 12, and control device 13 in the form of a block diagram. Detector device 11, localization device 12, and control device 13 are designed in the embodiment as separate components, which can communicate with each other via communication links.

Detector device 11 and control device 13 can be connected to each other via a first communications link 31. Control device 13 can be connected to localization device 12 via a second communications link 32. The communication links can be designed as wireless communication links, for example as radio, infrared, Bluetooth, WLAN or W-Fi links, or as cabled communication links. Besides the listed wireless link technologies, all already known and future wireless communication technologies for data and image transmission are suitable.

Control device 13 includes a housing 33, into which is integrated an operating device 34 and a display device 35. Operating device 34 and display device 35 can be designed as separate parts as shown in FIG. 2 or jointly integrated into a touch screen for example. Control device 13 also has an evaluation and control element 36, a storage element 37 and a first transmit and receive element 38.

Detection device 11 includes a sensor device 41, a control element 42 for controlling sensor device 41 and a second transmit and receive element 43. Originating at first transmit and receive element 38 of control device 13, the first communications link to second transmit and receive element 43 of detector device 11 is set up. The commands for detector device 11 are transmitted by control device 13 via first communications link 31 to control element 42 of detector device 23. The sensor device has a single sensor element or multiple sensor elements; the sensor elements may be designed as inductive sensors, capacitive sensors, radar sensors, magnetic field sensors, or as other sensors suitable for detecting objects in substrates.

Localization device 12 includes a measuring device 44, a control and evaluation element 45 for controlling measuring device 44 and for evaluating the measured values as well as a third transmit and receive element 46. Locator device 12 is designed for example as a total station and the measuring device 44 is designed as a distance and angle measuring device. Originating at first transmit and receive element 38 of control device 13, second communications link 32 to third transmit and receive element 46 of localization device 12 is set up.

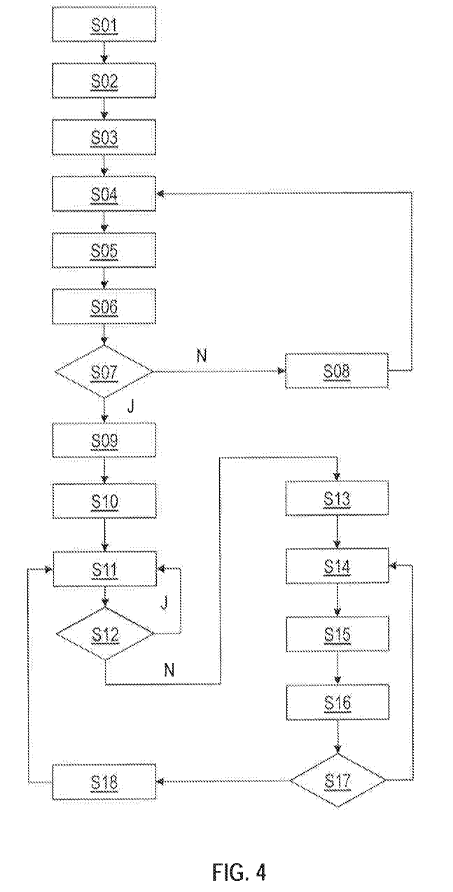

FIG. 4 illustrates the method according to the invention for detecting a measurement region in a substrate using a flow chart. The method is described using measurement region 21 of FIG. 2, which is arranged in back wall 18.

In a step S01, the user selects via operating device 34 measuring region 21 to be detected having start position Eᵤₗ and the coordinates; in a step S02, measurement region 21 is uploaded into control device 13. Prior to starting the process, the user can establish one of the corner points as the start position or control device 13 decides, while the process is performed, which of the corner points lies closer, and defines that one as the start position. In the embodiment of FIG. 4, left bottom end point Eᵤₗ of measurement region 21 is defined as the start position.

In a step S03, the user starts to execute the process. After the start in step S03, localization device 12 determines in a step S04 current position Pₐₖₜ and current orientation Oₐₖₜ of detector device 11 on back wall 18, which is transmitted in a step S05 by localization device 12 to control device 13. In a step S06, control device 13 determines from current position and orientation Pₐₖₜ, Oₐₖₜ current detection field 23 of detector device 11 and compares in a step S07 the start position against current detection field 23. In step S07, control device 13 thereby checks whether start position Eᵤₗ of measurement region 21 is located within current detection field 23.

If start position Eᵤₗ of measurement region 21 is located outside of current detection field 23 (N in S07), control device 13 generates in a step S08, from current position and orientation Pₐₖₜ, Oₐₖₜ of detector device 11 and start position Eᵤₗ, an adjustment instruction for detector device 11, which is depicted on display device 35. The method according to the invention is continued with step S04. If start position Eᵤₗ is located within current detection field 23 (J in S07), in a step S09 control device 13 issues a command to detector device 11 to take measurements in substrate 18 using a measuring frequency, and determines in a step S10 an adjustment instruction, from current position and orientation Pₐₖₜ, Oₐₖₜ and the coordinates of measurement region 21, how detector device 11 is to be moved over measurement region 21 to be detected. In a step S11, localization device 12 determines current position and orientation Pₐₖₜ, Oₐₖₜ using a localization frequency and transmits the position data to control device 13. Control device 13 determines from current position and orientation Pₐₖₜ, Oₐₖₜ current detection field 23 and in a step S12 compares the coordinates of measurement region 21 to be detected against current detection field 23.

If the coordinates of measurement region 21 are located within current detection field 23 (J in S12), the method according to the invention is continued with step S11. If the coordinates of measurement region 21 are located outside current detection field 23 (N in S12), control device 13 issues in a step S13 a command to detector device 11 to discontinue the measurements in substrate 18. In a step S14, control device 13 determines from current position and orientation Pₐₖₜ, Oₐₖₜ of detector device 11 and the coordinates of measurement region 21 an adjustment instruction, which is depicted on display device 35.

In a step S15, current position and orientation Pₐₖₜ, Oₐₖₜ of detector device 11 are determined by localization device 12 and transmitted to control device 13. In a step S16, control device 13 determines from current position and orientation Pₐₖₜ, Oₐₖₜ of detector device 11 current detection field 23, and in a step S17, it compares the coordinates of measurement region 21 to be detected against current detection field 23. In step S17, control device thereby checks whether the coordinates of measurement region 21 to be detected are located within current detection field 23.

If the coordinates of measurement region 21 are located outside of current detection field 23 (N in S17), the method according to the invention is continued with step S14. If the coordinates of measurement region 21 are located within current detection field 23 (J in S17), control device 13 generates in a step S18 a command to detector device 11 to continue the measurement in substrate 18. The method according to the invention is continued with step S11.

1-14. (canceled)

15. A method for detecting a measurement region in a substrate by an apparatus, wherein the apparatus comprises a detector device having a detection field, a localization device, and a control device, the method comprising the steps of:
selecting a first measurement region to be detected having a start position and coordinates, wherein dimensions of the first measurement region to be detected are greater than the detection field of the detector device;
determining by the localization device a current position of the detector device;
determining by the control device a current detection field from the current position of the detector device; and
comparing by the control device the start position of the measurement region to be detected against the current detection field.

16. The method according to claim 15, further comprising the steps of:
calculating by the control device an adjustment instruction for the detector device from the current position of the detector device and the start position of the measurement region to be detected; and
depicting the adjustment instruction for the detector device on a display device if the start position is located outside of the current detection field.

17. The method according to claim 15, further comprising the step of:
issuing a command by the control device to the detector device to execute at least one measurement in the substrate if the start position of the measurement region to be detected is located within the current detection field.

18. The method according to claim 15, further comprising the steps of:
generating by the control device an operating instruction to stop the detector device; and
depicting the operating instruction on a display device if the start position of the measurement region to be detected is located within the current detection field.

19. The method according to claim 18, further comprising the step of:
issuing a command by the control device to the detector device to execute at least one measurement in the substrate if the start position of the measurement region to be detected is located within the current detection field and the detector device is not moved.

20. The method according to claim 17, further comprising the steps of:
during the measurement using the detector device, calculating by the control device an adjustment instruction for the detector device from the coordinates of the measurement region to be detected and the current position of the detector device; and
depicting the adjustment instruction for the detector device on a display device.

21. The method according to claim 20, further comprising the step of:
executing by the detector device measurements in a substrate using a measurement frequency and the measurement values are transmitted using a first transmission frequency by the detector device to the control device.

22. The method according to one of the claim 20, wherein the current position of the detector device is determined by a localization device using one localization frequency, and the position data is transmitted using a second transmission frequency by the localization device to control device.

23. The method according to claim 20, further comprising the step of:
issuing by the control device a command to the detector device to discontinue taking measurements in the substrate if the coordinates of the measurement region to be detected are located outside of the current detection field.

24. The method according to claim 23, further comprising the steps of:
calculating by the control device an adjustment instruction for the detector device from the current position of the detector device and the coordinates of the measurement region to be detected; and
depicting the adjustment instruction for the detector device on the display device.

25. The method according to claim 24, further comprising the step of:
issuing by the control device a command to the detector device to execute at least one measurement in the substrate if the coordinates of the measurement region to be detected are located within the current detection field.

26. The method according to claim 21, wherein the detector device is moved at least two times over the measurement region to be detected, and wherein first measurements are taken using first detection parameters and second measurements are taken with second detection parameters by the detector device.

27. The method according to claim 15, wherein a current orientation of the detector device is determined using the localization device.

28. The method according to claim 27, wherein the current detection field of the detector device is determined from the current position and current orientation of the detector device.

29. The method according to claim 19, further comprising the steps of:
during the measurement using the detector device, calculating by the control device an adjustment instruction for the detector device from the coordinates of the measurement region to be detected and the current position of the detector device; and
depicting the adjustment instruction for the detector device on a display device.

30. The method according to one of the claim 21, wherein the current position of the detector device is determined by a localization device using one localization frequency, and the position data is transmitted using a second transmission frequency by the localization device to control device.
